(19) United States
(12) Patent Application Publication
(10) Pub. No.: US 2004/0160918 A1
(43) Pub. Date: Aug. 19, 2004

(54) Methods, apparatus and computer program products for acquiring traffic channels using negative systems

(76) Inventor: Murali Narasimha, Raleigh, NC (US)

Correspondence Address: MYERS BIGEL SIBLEY & SAJOVEC, PO BOX 37428, RALEIGH, NC, 27627, US

(21) Appl. No.: 10/366,196

(22) Filed: Feb. 13, 2003

(51) Int. Cl. H04B 7/216

(52) U.S. Cl. 370/335

(57) ABSTRACT

The present invention provides methods, apparatus and computer program products for acquiring an available channel in a code division multiple access (CDMA) wireless communications system by creating a scan list of channels in a target geographic region responsive to locating a negative system in the target geographic region during a scan of a prior geographic region. The scan list of channels in the target geographic region is scanned to acquire an available channel in the wireless communications system.

### BACKGROUND OF THE INVENTION

The present invention relates to wireless communications, and more particularly, to code division multiple access (CDMA) communications.

Conventional CDMA mobile terminals use data structures and algorithms collectively known as system selection for preferred roaming (SSPR) to choose which systems the mobile terminal can operate in at a particular time and in a particular location and/or region as described in Over-the-Air Service Provisioning of Mobile Stations in Spread Spectrum Systems. See TIA/EIA/IS-683-A. The mobile terminal has access to a preferred roaming list (PRL) that indicates which systems the mobile terminal should use, i.e. the preferred systems, and in what order the mobile terminal should try to access these preferred systems. The PRL may also indicate which systems should not be used by the mobile terminal, i.e. negative systems. The content of the PRL is typically controlled by the carrier or service provider and stored on the mobile terminal. The PRL gives service providers or carriers flexibility in defining which systems the mobile terminal can use to provide service, which in turn may allow the carriers to maximize their own revenue and control roaming.

The PRL generally consists of two tables, a system table and an acquisition table. The system table contains one or more system records including information particular to the systems in the system table. In particular, each system record in the system table may include an acquisition index that points to a particular acquisition record in the acquisition table. The acquisition record provides, for example, one or more frequencies or channels that the mobile terminal can use when attempting to acquire a system.

Coverage areas in a CDMA system are generally broken up into geographic regions (Geo regions). The boundaries of a particular geographic region may be defined, for example, by the boundaries or borders of a town, a city, a state or the like. Within each geographic region, many different systems may be available to the mobile terminal. Each of these systems may be listed on the PRL in an order of priority, from the most preferred system to the least preferred system. Furthermore, as discussed above, some of the systems listed in the PRL may be marked as negative systems. The content of the PRL is typically entirely controlled by the service provider.

Currently, when a mobile terminal loses a channel in a serving system, for example, as the mobile customer enters a region where the radio frequency (RF) signal is poor, a scan is performed for other channels in the same geographic region as the lost serving system. If a channel cannot be acquired in the same geographic region as the lost serving system, a scan of all the channels in the acquisition table is typically performed, i.e. an initial or power up scan is performed, which may be very time consuming. Accordingly, as the coverage areas for cellular service increase in size, the number of systems in the system table and channels in the acquisition table may also increase. An increase in the number of channels in the acquisition table may cause the time required for a full initial scan to increase significantly, thereby possibly sacrificing overall performance of the mobile terminal.

### SUMMARY OF THE INVENTION

According to embodiments of the present invention a scan list of channels in a target geographic region of a code division multiple access (CDMA) wireless communications system is created responsive to locating a negative system in the target geographic region during a scan of a prior geographic region. The scan list of channels in the target geographic region is scanned to acquire an available channel in the wireless communications system. The present invention maybe embodied as methods of operating wireless communications systems and/or terminals, wireless communications apparatus, such as network components and terminals, and computer program products including program code configured to execute in a wireless communications apparatus.

### BRIEF DESCRIPTION OF THE DRAWINGS

FIG. 1 is a block diagram of a mobile terminal according to embodiments of the present invention and a base station transceiver;

FIG. 2 is a diagram illustrating exemplary operating environments according to embodiments of the present invention;

FIG. 3 is a flow chart illustrating operations for acquiring a channel in a preferred system using negative systems according to embodiments of the present invention;

FIG. 4 is a flow chart illustrating operations for acquiring a channel in a preferred system using negative systems according to further embodiments of the present invention; and

FIG. 5 is a flow chart illustrating operations for acquiring a channel in a preferred system using negative systems according to still further embodiments of the present invention.

### DETAILED DESCRIPTION

The present invention will now be described more fully hereinafter with reference to the accompanying drawings, in which illustrative embodiments of the invention are shown. This invention may, however, be embodied in many different forms and should not be construed as limited to the embodiments set forth herein; rather, these embodiments are provided so that this disclosure will be thorough and complete, and will fully convey the scope of the invention to those skilled in the art.

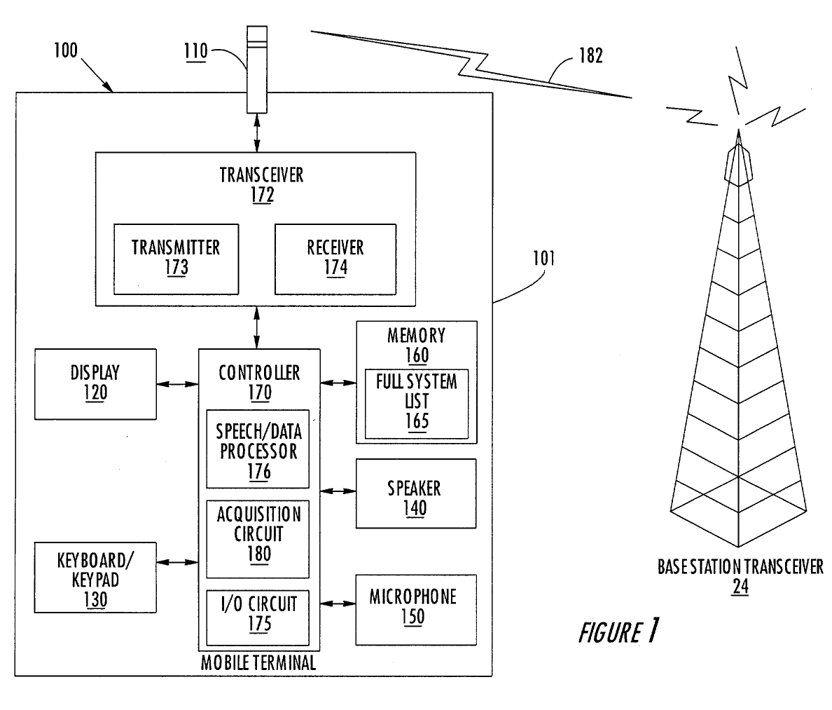

In the present application, FIGS. 1 through 5 are diagrams illustrating exemplary apparatus and operations according to embodiments of the present invention. It will be understood that operations depicted in the diagrams, and combinations thereof, may be implemented using one or more electronic circuits, such as a circuits included in a component of a wireless communications system or in a wireless terminal. It will also be appreciated that, in general, operations depicted in the diagrams, and combinations thereof, may be implemented in one or more electronic circuits, such as in one or more discrete electronic components, one or more integrated circuits (ICs), one or more application specific integrated circuits (ASICs), and application specific circuit modules, and/or by computer program instructions which may be executed by a computer or other data processing apparatus, such as a microprocessor or digital signal processor (DSP), to produce a machine such that the instructions which execute on the computer or other programmable data processing apparatus create electronic circuits or other means that implement the specified operations. The computer program instructions may also be executed on one or more computers or other data processing apparatus to cause a series of actions to be performed by the computer(s) or other programmable apparatus to produce a computer implemented process that includes the specified operations.

The computer program instructions may also be embodied in the form of a computer program product in a computer-readable storage medium, i.e., as computer-readable program code embodied in the medium for use by or in connection with an instruction execution system. The computer-readable storage medium may include, but is not limited to, electronic, magnetic, optical or other storage media, such as a magnetic or optical disk or an integrated circuit memory device. For example, the computer program instructions may be embodied in memory included in a component of a wireless communications apparatus and/or storage medium operable to program such memory. Accordingly, blocks of the schematic diagrams of FIGS. 1 through 5 support electronic circuits and other apparatus that perform the specified operations, acts for performing the specified operations, and computer program products configured to perform the specified operations.

According to various embodiments of the present invention, available channels are acquired or re-acquired in a code division multiple access (CDMA) wireless communications system by selecting channels to scan in a target geographic region based on a negative system located in the target geographic region during a previous scan of a prior geographic region. Utilizing the negative system previously located to focus a later scan may reduce the likelihood of having to perform a full initial scan of an entire acquisition table, which may be very time consuming. Accordingly, the time dedicated to and the power consumed in acquiring or re-acquiring channels in a CDMA wireless system may be reduced, thereby, possibly improving the overall performance of the mobile terminal.

Embodiments of the present invention will now be described with reference to the schematic block diagram illustration of a wireless terminal in FIG. 1. FIG. 1 illustrates an exemplary radiotelephone communication system, in accordance with some embodiments of the present invention, which includes a mobile wireless terminal 100 and a base station transceiver 24. The mobile terminal 100 may comprise, in a portable housing 101, a keyboard/keypad 130, a display 120, a speaker 140, a microphone 150, a transceiver 172, and a memory 160 that communicate with a controller 170.

The transceiver 172, as illustrated, includes a transmitter circuit 173 and a receiver circuit 174, which, respectively, transmit outgoing radio frequency signals to the base station transceiver 24 and receive incoming radio frequency signals from the base station transceiver 24 via an antenna 110. The radio frequency signals transmitted between the mobile terminal 100 and the base station transceiver 24 may comprise both traffic and control signals (e.g., paging signals/messages for incoming calls), which are used to establish and maintain communication with another party or destination. The transceiver 172 may further operate to provide signals from the base station to the I/O circuit 175.

Various of the foregoing components of the mobile terminal 100, other than those described further herein, may be included in many conventional mobile terminals and their functionality is generally known to those skilled in the art. It should be further understood, that, as used herein, the term “mobile terminal” or “wireless terminal” may include a cellular radiotelephone with or without a multi-line display; a Personal Communications System (PCS) terminal that may combine a cellular radiotelephone with data processing, facsimile and data communications capabilities; a Personal Data Assistant (PDA) that can include a radiotelephone, pager, Internet/intranet access, Web browser, organizer, calendar and/or a global positioning system (GPS) receiver; and a conventional laptop and/or palmtop receiver or other appliance that includes a radiotelephone transceiver. Mobile terminals may also be referred to as “pervasive computing” devices.

The base station transceiver 24 comprises the radio transceiver(s) that define individual cell(s) or geographic region(s) (Geo) in a cellular network and communicate with the mobile terminal 100 and other mobile terminals in the cell or geographic region using a radio-link protocol. Although only a single base station transceiver 24 is shown, it will be understood that many base station transceivers may be connected through, for example, a mobile switching center and other devices to define a wireless communication network.

The controller 170 may include a speech/data processing circuit 176 as well as other functional modules not illustrated in FIG. 1 but which will be understood to those of skill in the art related to wireless communications including both data and voice communication support. As used herein, the speech/data processing circuit 176 may include components such as demodulators, decoders, interleavers and radio frequency (RF) processor circuitry. The controller 170, such as a microprocessor, microcontroller or similar data processing device, may execute program instructions stored in a memory 160 of the mobile terminal 100, such as a dynamic random access memory (DRAM), electrically erasable programmable read-only memory (EEPROM) or other storage device.

The transceiver 172, the speech/data processing circuit 176 and other components of the mobile terminal 100 may be implemented using a variety of hardware and software. For example, operations of the transceiver 172 and/or the speech/data processing circuit 176 may be implemented using special-purpose hardware, such as an application specific integrated circuit (ASIC) and programmable logic devices such as gate arrays, and/or software or firmware running on a computing device such as a microprocessor, microcontroller or digital signal processor (DSP). Although functions of the transceiver 172 and the other circuits shown in FIG. 1 may be integrated in a single device, such as a single ASIC microprocessor, they may also be distributed among several devices. Aspects of these circuits may also be combined in one or more devices, such as an ASIC, DSP, microprocessor or microcontroller. These various implementations using hardware, software, or a combination of hardware and software will generally be referred to herein as “circuits.”

In accordance with various embodiments of the present invention, an acquisition circuit 180 disposed within controller 170 of the mobile terminal 100 is configured to acquire or re-acquire available radio channels of a system listed in a full system list 165 for the mobile terminal 100. The full system list 165 may be, for example, a preferred roaming list (PRL). A PRL is typically programmed by the service provider and/or carrier and stored in the memory of the mobile terminal, for example, memory 160. The PRL includes a series of tables that indicate which systems, for example, a personal communications service (PCS) CDMA system, a cellular CDMA system and/or a cellular analog system, the mobile terminal 100 should use, i.e. the preferred systems. The PRL may also include an indication of which systems should not be used by the mobile terminal 100, i.e. the negative systems. Although embodiments of the present invention are described herein with respect to the PRL, the present invention should not be limited to this configuration.

In particular, the PRL may include two tables, a system table and an acquisition table. Exemplary system and acquisition tables are illustrated in Tables 1 and 2, respectively, below. As illustrated in Table 1, the system table contains one or more system records corresponding to, for example, systems having system identification numbers (SIDs) 5205, 218, 5142 and so on. Each system record includes a SID and a network identification number (NID) for the corresponding system. As illustrated, each system record also contains an indication as to whether the system is a preferred system or a negative system (Pref_Neg). If the Pref_Neg bit is set to “Pref” or “1” in the system table, the system is a preferred system. If, on the other hand, the Pref_Neg bit is set to “Neg” or “0” the system is a negative system.

TABLE 1
System Table

| | | PREF_{—} | | | ACQ_Index | ROAM_{—} |
|---|---|---|---|---|---|---|
| SID | NID_INCL | NEG | GEO | PRI | (ACQ_Type) | IND |
| 5205 | 65535 | Pref(1) | New | More | 2 | Off |
| 218 | 65535 | Neg(0) | Same | Same | 1 | Off |
| 5142 | 65535 | Pref(1) | Same | Same | 0 | Flashing |
| 4176 | 65535 | Neg(0) | Same | Same | 7 | N/A |
| 227 | 65535 | Pref(1) | Same | Same | 3 | Off |
| 4151 | 65535 | Pref(1) | New | Same | 4 | On |
| 5116 | 65535 | Pref(1) | Same | More | 6 | On |
| 4654 | 65535 | Neg(1) | Same | Same | 5 | On |
| 37 | 65535 | Pref(1) | Same | Same | 8 | N/A |

As further illustrated in Table 1, the system table includes an indication as to what geographic region the system is situated (Geo). In particular, the coverage areas in a code division multiple access (CDMA) network are generally broken up into different geographic regions (Geos). “New” in the Geo field of the system table indicates a start of a new geographic region in the system table. “Same” in the Geo field of the system table indicates that the system defined by the current system record is in the same geographic region as the system defined by the previous system record in the system table. Accordingly, for example, the systems having SIDs 5205 through 227 in Table 1 are in a first geographic region and the systems having SIDs 4151 through 37 are in a second geographic region.

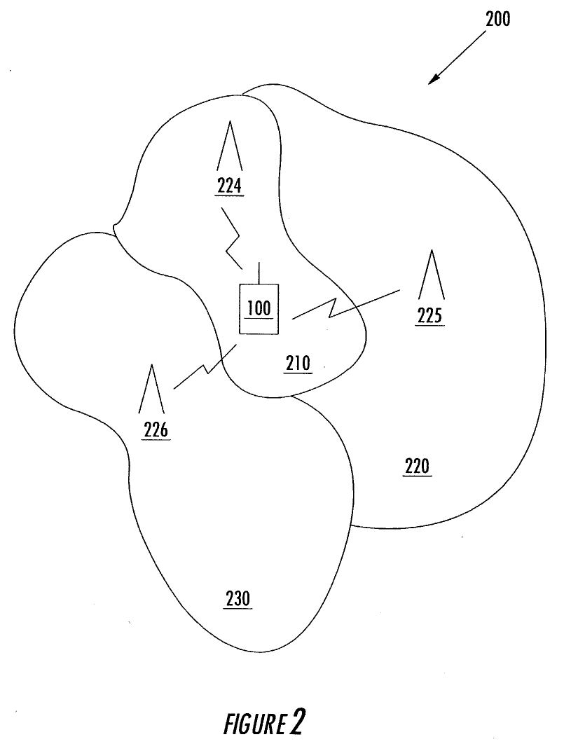

FIG. 2 illustrates a coverage area 200 of a CDMA wireless communications system that is broken up into first, second and third geographic regions 210, 220 and 230, respectively. The boundaries of a geographic region can be defined, for example, by the boundaries of a town, a city, a state or the like. FIG. 2 will be discussed further below.

Referring again to Table 1, each system record also contains an indication as to the relative priority of the system with respect to the other systems in the same geographic region listed in the system table (PRI). The system table is set up such that the most preferred system in a particular geographic region is listed first and the least preferred system in a the same geographic region is listed last. Thus, “More” in the priority field indicates that this system has a higher priority than the system listed in the next system record. If, on the other hand, the priority field is set to “Same”, this indicates that the priority of the system defined by this system record is the same as the system defined by the next system record in the system table. Each system record in the system table also includes a roaming status (Roam_Ind) that should be indicated by the mobile terminal 100 if the particular system is being used. A mobile terminal is “roaming”, for example, if the mobile terminal is operating in a system not supported by the service provider. The roaming status of a mobile terminal can also be influenced by the mobile customer's service agreement, for example, if the service agreement is nationwide or regional. Finally, each system record in the system table also includes an acquisition index (Acq_Index), which points to an acquisition record in the acquisition table of the PRL, which will be discussed below with respect to Table 2.

It will be understood that the system table illustrated in Table 1 is provided for exemplary purposes only and that the present invention is not limited to this configuration. Typically, each carrier or service provider configures a unique PRL for that particular service provider or carrier. Accordingly, each carrier has the flexibility to define which systems mobile terminals subscribing to their service can use. This allows the service providers to customize their networks to maximize their own revenue and control roaming into unapproved systems that may or may not be maintained by a competitor.

As illustrated in Table 2, an acquisition table may contain one or more acquisition records, for example, records 0 through 8 of Table 2. The acquisition records in the acquisition table are in order of priority, from highest priority to lowest priority. As illustrated in Table 2, an acquisition index (Acq_Index) points to an acquisition record in the acquisition table. Each acquisition record provides the acquisition type of the system being accessed (Acq_Type) and the acquisition parameters, i.e. the frequencies or channels that the mobile terminal is to use when attempting to acquire the corresponding system. It will be understood that the acquisition table illustrated in Table 2 is provided for exemplary purposes only and that the present invention is not limited to this configuration.

TABLE 2
Acquisition Table

| | | Acquisition |
|---|---|---|
| Acquisition Index | Acquisition Type | Parameters |
| (ACQ_Index) | (ACQ_TYPE) | (Frequencies) |
| 0 | 6 | 1175, 1150, 1125, |
| | | 1100, 1075 |
| 1 | 6 | PCS Block C |
| 2 | 6 | 50, 100, 75, 475 |
| 3 | 6 | 283, 691 |
| 4 | 1 | System B |
| 5 | 6 | 50, 200, 25, 100, |
| | | 250, 75 |
| 6 | 6 | 384, 777 |
| 7 | 6 | 500, 625, 350 |
| 8 | 6 | 25, 200, 350, 750 |

CDMA systems may include PCS CDMA using an 1800 MHz frequency band and cellular CDMA using an 800 MHZ frequency band. In a PCS CDMA system, the frequencies can be assigned in an acquisition table using predefined blocks of frequencies or using a series of channels. When a block system is used, the mobile terminal may have to search all of the preferred frequency assignments within the frequency block to determine whether it can acquire a channel in the system. For A, B and C blocks, there are generally eleven preferred frequency assignments. Because the acquisition time may be proportional to the number of preferred frequency assignments scanned, specifying the entire frequency block may increase acquisition time. Thus, if a smaller set of frequencies is sufficient, PCS CDMA system acquisition using channels is typically used. Furthermore, the cellular CDMA frequency band (800-830 MHz) is generally partitioned into an A frequency band and a B frequency band. The A frequency band typically has a primary channel of 283 and a secondary channel of 691. Similarly, the B frequency band typically has a primary channel of 384 and a secondary channel of 777.

Referring again to FIG. 1, according to embodiments of the present invention, when a channel on a serving system is lost, the acquisition circuit 180 is configured to scan the network for an available channel in a system listed on the PRL using located negative systems to decrease the likelihood of having to perform a full initial scan, i.e. a scan of all of the channels in the acquisition table. The following example illustrates the use of negative systems to acquire or re-acquire an available channel in a system listed on the PRL according to embodiments of the present invention.

The present invention will now be further described with reference to embodiments shown in FIG. 2. Networks broadcast system information including, for example, SIDs and NIDs of available systems. This information is available to a mobile station 100 that is configured to receive the broadcast control signal from one or more base stations, for example, first, second and third base stations 224, 225 and 226, respectively. After being powered on, the mobile terminal 100 does a full initial scan of the broadcast signals from, for example, first, second and third base stations 224, 225 and 226, respectively, to locate an available channel on a system and acquire the available channel. An initial scan is a scan of all of the channels in the acquisition table, for example, Table 2. Once the mobile terminal 100 locates an available channel, the mobile terminal acquires the available channel and determines the SID and/or NID of the system in which the available channel is located. If the system having the determined SID and/or NID is not in the PRL, service may still be provided and a roaming status may be indicated by the mobile terminal 100. When roaming the mobile terminal may continue to try to acquire an available channel in a system listed on the PRL.

If the system including the acquired channel is listed in the PRL, it may be determined if the system having this SID and/or NID is the most preferred system listed on the PRL. If the system including the acquired channel is not the most preferred system, the mobile terminal 100 may periodically re-scan the network for a channel in a more preferred system until the a channel in the most preferred system listed in the PRL is acquired. Once a channel in the most preferred system is acquired, the mobile terminal 100 may remain on the most preferred channel until the mobile terminal is powered off or the serving system/channel is lost. The system may be lost because, for example, the mobile customer travels into a region where the RF signal is poor.

It will be understood that the acquired channel does not have to be in the same geographic region as the mobile terminal 100. For example, if the mobile terminal 100 is on the border of two geographic regions, for example, the first geographic region 210 and the third geographic region 230 as illustrated in FIG. 2, the mobile terminal 100 may be closer to the third base station 226 in the third geographic region 230 than to the first base station 224 in the first geographic region 210 or otherwise receive a stronger signal, for example, due to terrain features. Accordingly, it is possible that the mobile terminal 100 may acquire a channel on a system in the third geographic region 230 instead of the first geographic region 210 in which it is located.

Referring again to FIG. 2, when the acquired channel is lost, the acquisition circuit 180 (FIG. 1) of the mobile terminal 100 creates a scan list for the geographic region 210 in which the mobile terminal 100 is located. The scan list may include the channels listed in the acquisition table for the systems in the first geographic region 210. For example, if the first geographic region 210 corresponds to the geographic region in Table 1 occupying the first five records, the scan list would consist of the channels corresponding to acquisition index numbers 2, 0 and 3. The channels corresponding to acquisition indexes 1 and 7 are not included in the scan list because these acquisition indexes correspond to systems marked as negative systems in the PRL. Using the acquisition table in Table 2 to expand the scan list by replacing the acquisition indexes with the channels the acquisition indexes point to, the scan list would consist of channels 50, 100, 75, 475, 1175, 1150, 1125, 1100, 1075, 283 and 691. The channels in the scan list will generally be scanned in this order.

While scanning these channels, the mobile terminal 100 may find an available channel on a system in another geographic region that is marked as a negative system on the PRL. For example, while scanning channel 50 in the scan list set out above, the mobile terminal may receive and demodulate channel 50 from a system having the SID 4654 in the third geographic region 230. As illustrated in Table 1, the system having the SID 4654 is marked as a negative system in a different geographic region. If during the scan of the scan list created above, an available channel in a negative system is located, the negative system is identified and its system information (SID) is saved by the acquisition circuit 180 (FIG. 1).

A scan of a channel in a first geographic region 210 may find CDMA service on a like numbered channel in another geographic region because the CDMA system is generally designed to re-use a small set of wide channels. For example, as discussed above, the 800 MHz band is generally divided into an A frequency band and a B frequency band, each of which has primary and secondary channels (284, 692, 384, 777). Operators in the CDMA system typically deploy service on these four channels before deploying service on the other channels. Once the mobile terminal acquires service on one of these four channels, the mobile terminal may be diverted to different channels in the 800 MHz band. In the 1800 MHz (PCS) band, there is a selected set of channels used in a similar manner. Thus, CDMA communications systems generally use a few wide channels that allow soft handoffs and other types of handoffs without necessarily requiring a frequency change, thus, possibly improving the overall performance of the system.

In certain embodiments of the present invention, the scan list set out above is modified. For example, in some embodiments of the present invention, the channel that was first acquired and then lost is inserted into the scan list set out above after every N channels are scanned. The value of N may be from about 2 channels to about 10 channels, but, typically, is about 5 channels. In these embodiments, it is considered advantageous to re-acquire the lost channel. By way of further example, in some mobile terminals 100 the acquisition circuit 180 (FIG. 1) is configured to maintain a list of the most recently used (MRU) channels. In these embodiments, the channels listed in the MRU are added to the beginning of the scan list set out above and are scanned before the rest of the scan list.

If a channel is not acquired during the scan of the channels in the first geographic region 210 and a negative system was identified during this scan, the acquisition circuit 180 (FIG. 1) uses, for example, the SID of the located negative system identified to index into the PRL for the geographic region including the identified negative system. For exemplary purposes, assume that the identified negative system was located in the third geographic region 230 in FIG. 2. Thus, for example, if the negative system having the SID 4654 is identified, the acquisition circuit 180 (FIG. 1) uses this SID to index into the PRL for the third geographic region 230, which includes systems having SIDs 4151, 5116, 4654 and 37 as illustrated in Table 1.

The acquisition circuit 180 creates a scan list for the geographic region 230 in which the identified negative system is located. The scan list may include the channels listed in the acquisition table for the systems in the first geographic region 210. For example, if the third geographic region 230 corresponds to the geographic region in Table 1 corresponding to the sixth through ninth records, the scan list would consist of the channels corresponding to acquisition index numbers 4, 6 and 8. The channels corresponding to the acquisition index 5 of the negative system 4654 are not included in the scan list. Using the acquisition table in Table 2 to expand the scan list, the scan list would consist of the channels in system B, channels 384 and 777 (the primary and secondary channels of the B band of the 800 MHz frequency band) and channels 25, 200, 350 and 750. A scan of these channels may be more likely to acquire a channel in the third geographic region 230 because identification of negative system 4654 in a scan may indicate that the mobile terminal 100 is on the border of the first 210 and third 230 geographic regions. However, if an available channel is still not acquired by the scan of the geographic region including the negative system, a full initial scan may be performed to acquire an available channel.

As discussed above, marking negative systems identified during a scan of first geographic region and using these marked systems to identify a second geographic region likely to contain an available channel on a preferred system may reduce the likelihood of having to perform a full initial scan of the entire acquisition table (initial or power up scan). If an initial scan can be avoided, the overall performance of the mobile terminal may be improved by decreasing the scan time.

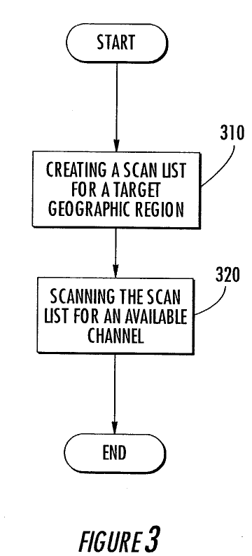

Operations according to embodiments of the present invention will now be discussed with respect to FIGS. 3 through 5. FIGS. 3 through 5 are flowchart illustrations of operations that may be carried out by the mobile terminal 100 according to some embodiments of the present invention. Referring to FIG. 3, a scan list of channels in a geographic region that includes a negative system (a target geographic region) is created (block 310). The scan list of channels in the target geographic region is created responsive to locating the negative system during a prior scan of a geographic region in which the mobile terminal 100 is located (a prior geographic region). The scan list of channels in the target geographic region is scanned to acquire an available channel (block 320). The available channel in the target geographic region may be located in one or more system records associated with the target geographic region. The system records associated with the target geographic region may be a portion of a full system list, for example, a preferred roaming list (PRL).

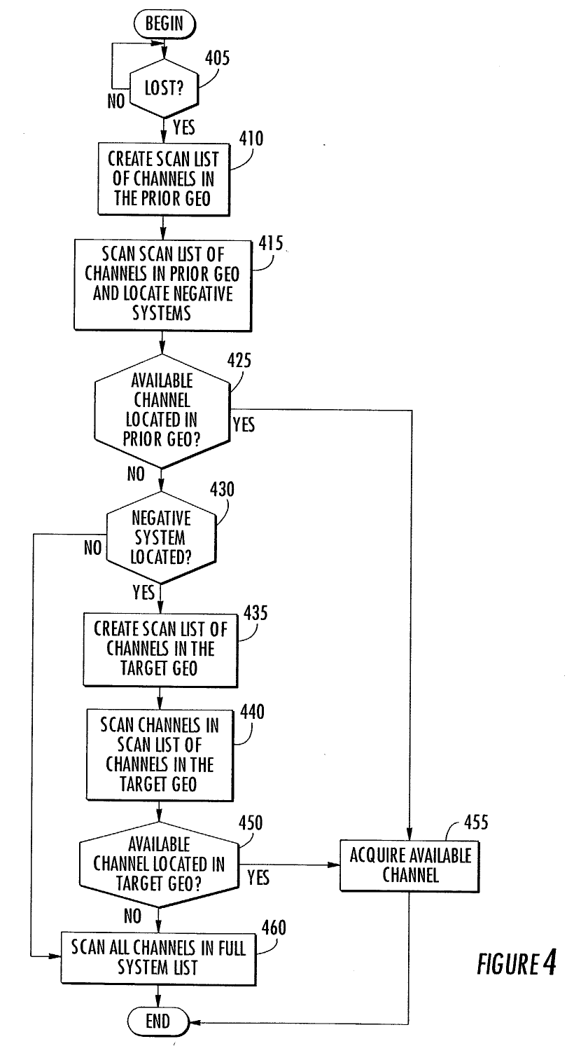

Referring now to FIG. 4, operations of acquiring available channels in a CDMA wireless communications system according to further embodiments of the present invention will be discussed. It is determined if the mobile terminal 100 has lost its the channel on the current serving system (block 405). If it is determined that the mobile terminal 100 has not lost its channel, the mobile terminal 100 remains on the acquired channel until it loses the serving system on which the channel is located or the mobile terminal 100 is powered off. If, on the other hand, it is determined that the mobile terminal has lost its channel (block 405), a scan list of channels is created based on the PRL for the geographic region in which the mobile terminal is located in (the prior geographic region)(block 410). As discussed above, a scan list may be created by including the channels listed in the acquisition table that correspond to system records in the PRL for the first geographic region. The channels in the scan list for the first geographic region are scanned for an available channel in a preferred system and to locate negative systems (block 415). The available channel in the prior geographic region may be located in one or more system records associated with the prior geographic region. The system records associated with the prior geographic region may be a portion of a full system list, for example, a preferred roaming list (PRL).

In certain embodiments of the present invention, the channel that was first acquired and now lost is inserted into the scan list set out above after every N channels are scanned. The value of N may be from about 2 channels to about 10 channels, but typically is about 5 channels. In these embodiments, it is considered advantageous to re-acquire the same channel as was lost so it is scanned for repeatedly. By way of further example, in some mobile terminals 100 the acquisition circuit 180 is configured to maintain a list of the most recently used (MRU) channels. In these embodiments, the channels listed in the MRU may be added to the beginning of the scan list set out above and scanned first.

If an available channel was acquired during the scan of the channels in the first geographic region (block 425), the available channel is acquired (block 455). If, on the other hand, the available channel has not been located (block 425), it is determined if a negative system was located (block 430). If a negative system was not located, an full initial scan is performed for the channels in the acquisition table (block 460). If, on the other hand, one or more negative systems was identified (block 425), a scan list is created for the geographic region including the negative system (the target geographic region) (block 435). As discussed above, the scan list may be created by including the channels associated with the preferred systems for the target geographic region listed in a system table. The channels in the scan list are scanned to acquire a preferred channel in a preferred system listed on the PRL (block 440). As discussed above, in certain embodiments, it is considered advantageous to reacquire the channel that was lost, therefore, in some embodiments the channel that was lost is inserted into the scan list multiple time, for example, after every N channels are scanned.

If an available preferred channel was located in the target geographic region (block 450), the channel is acquired by the mobile terminal (block 455). If, on the other hand, an available channel is not located during the scan of the target geographic region (block 450), a full initial scan is performed (block 460).

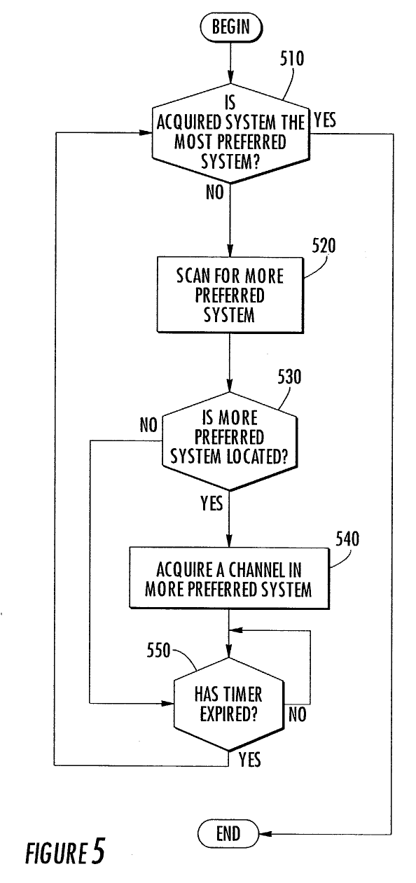

Referring now to FIG. 5, operations for acquiring channels using negative systems according to further embodiments of the present invention will be discussed. If the acquired channel is in the most preferred system listed in the preferred roaming list (block 510), i.e. listed at the top of the preferred roaming list for the particular geographic region the mobile terminal is located in, the mobile terminal remains on the current channel until the mobile terminal is powered off or the serving system is lost. If, on the other hand, the acquired channel is not in the most preferred system (block 510), the mobile terminal scans the geographic region for a channel in a more preferred system (block 520). If a more preferred system is located (block 530), a channel in the more preferred system is acquired by the mobile terminal (block 540). If a timer having a predetermined length has expired (block 550), operations return to block 510 and repeat until a channel in the most preferred system is acquired. If the timer has not expired (block 550), operations remain at block 550 until it is determined that the timer has expired. The timer may have a length of about 3 minutes.

If a more preferred system was not located (block 530), it is determined if a timer having a predetermined length has expired (block 550). If the timer has expired (block 550), operations return to block 510 and repeat until a channel in the most preferred system is acquired. If the timer has not expired (block 550), operations remain at block 550 until it is determined that the timer has expired.

As discussed briefly above with respect to FIGS. 1 through 5, according to various embodiments of the present invention, preferred systems are re-acquired in a code division multiple access (CDMA) wireless communications system after the serving system has been lost by scanning a plurality of channels in a geographic region including a negative system located during a scan of a geographic region in which the mobile terminal is situated. The located negative system is used to identify one or more geographic regions to scan before doing a power up or initial scan. Scanning a geographic system including the located negative system may reduce the likelihood of performing a power up or initial scan that may include a large number of channels corresponding to systems in a preferred roaming list. Accordingly, the time dedicated to acquiring channels in CDMA wireless communications systems may be reduced, which may improve the overall performance of the mobile terminal.

In the drawings and specification, there have been disclosed typical illustrative embodiments of the invention and, although specific terms are employed, they are used in a generic and descriptive sense only and not for purposes of limitation, the scope of the invention being set forth in the following claims.

That which is claimed is:

1. A method of acquiring an available channel in a code division multiple access (CDMA) wireless communications system, comprising:
creating a scan list of channels in a target geographic region responsive to locating a negative system in the target geographic region during a scan of a prior geographic region; and
scanning the scan list of channels in the target geographic region to acquire the available channel.

2. The method according to claim 1, wherein creating the scan list of channels in the target geographic region comprises creating a scan list of channels in the target geographic region based on one or more system records associated with the target geographic region, wherein each of the one or more system records associated with the target geographic region includes one or more channels corresponding to a system in the target geographic region.

3. The method according to claim 2, further comprising:
scanning the prior geographic region to acquire an available channel in the prior geographic region and to locate negative systems;
wherein scanning the scan list of channels in the target geographic region comprises scanning the scan list of channels in the target geographic region if an available channel is not acquired in the prior geographic region was not acquired and at least one negative system is located.

4. The method according to claim 3 further comprising:
creating a scan list of channels in the prior geographic region based on one or more system records associated with the prior geographic region, wherein each of the one or more system records includes one or more channels corresponding to a system in the prior geographic region; and
wherein scanning the prior geographic region comprises scanning the scan list of channels in the prior geographic region to acquire the available channel in the prior geographic region.

5. The method according to claim 4, further comprising:
acquiring at least one of the available channel in the prior geographic region and the available channel in the target geographic region; and
wherein scanning the scan lists of channels in the prior geographic region or the target geographic region further comprises inserting a previously acquired channel into the scan lists of channels in the prior geographic region or the target geographic region a plurality of times after every N channels are scanned if the previously acquired channel has been lost.

6. The method according to claim 5, further comprising:
creating a list of channels most recently acquired by a mobile terminal in the CDMA wireless communications system; and
wherein scanning the scan list of channels in the prior geographic region further comprises scanning the list of channels most recently acquired before scanning the scan list of channels in the prior geographic region.

7. The method according to claim 5 wherein the acquired channel is associated with an acquired system, the method further comprising:
scanning the system records associated with the prior geographic region or the target geographic region for a more preferred system than the acquired system if the acquired system is not a most preferred system listed in the system record associated with the prior geographic region or the system record associated with the target geographic region; and
acquiring a channel in the more preferred system if a more preferred system is identified during scanning of the system record associated with the prior geographic region or the system record associates with the target geographic region.

8. The method according to claim 7, further comprising:
repeating the steps of scanning the system record and acquiring a channel in the more preferred system until the acquired system is the most preferred system in the system record associated with the prior geographical region or the system record associated with the target geographical region.

9. The method according to claim 8, wherein repeating comprises repeating scanning the system record and acquiring a channel in the more preferred system responsive to a reselection timer.

10. The method according to claim 3 further comprising:
scanning a full system list for an available channel in the CDMA wireless communications system if the available channel in the target geographic region is not acquired during scanning of the scan list of channels in the target geographic region.

11. The method of claim 10, wherein the full system list comprises the system records associated with the prior geographic region and the system records associated with the target geographic region.

12. The method of claim 11, wherein the full system list comprises a preferred roaming list (PRL).

13. The method according to claim 1, wherein the prior geographic region comprises a first state and the target geographic region comprises a second state.

14. A CDMA wireless communication apparatus that acquires an available channel, comprising:
means for creating a scan list of channels in a target geographic region responsive to locating a negative system in the target geographic region during a scan of a prior geographic region; and
means for scanning the scan list of channels in the target geographic region to acquire the available channel.

15. The apparatus according to claim 14 wherein the means for creating the scan list of channels in the target geographic region comprises means for creating a scan list of channels in the target geographic region based on one or more system records associated with the target geographic region, wherein each of the one or more system records associated with the target geographic region includes one or more channels corresponding to a system in the target geographic region.

16. The apparatus according to claim 15 further comprising:
means for scanning the prior geographic region to acquire an available channel in the prior geographic region and to locate negative systems;
wherein the means for scanning the scan list of channels in the target geographic region comprises means for scanning the scan list of channels in the target geographic region if an available channel is not acquired in the prior geographic region and at least one negative system is located.

17. The apparatus according to claim 16 further comprising:
means for creating a scan list of channels in the prior geographic region based on one or more system records associated with the prior geographic region, wherein each of the one or more system records includes one or more channels corresponding to a system in the prior geographic region; and
wherein the means for scanning the prior geographic region comprises means for scanning the scan list of channels in the prior geographic region to acquire the available channel in the prior geographic region

18. A CDMA wireless terminal that acquires an available channel, comprising:
a radio communications circuit operative to send and receive radio signals; and
an acquisition circuit coupled to the radio communications circuit and configured to create a scan list of channels in a target geographic region responsive to locating a negative system in the target geographic region during a scan of a prior geographic region and scan the scan list of channels in the target geographic region to acquire the available channel.

19. The wireless terminal according to claim 18, wherein the acquisition circuit is further configured to create the scan list of channels in the target geographic region based on one or more system records associated with the target geographic region, wherein each of the one or more system records associated with the target geographic region includes one or more channels corresponding to a system in the target geographic region.

20. The wireless terminal according to claim 19, wherein the acquisition circuit is further configured to:
scan the prior geographic region to acquire an available channel in the prior geographic region and to locate negative systems; and
scan the scan list of channels in the target geographic region if an available channel is not acquired in the prior geographic region and at least one negative system is located.

21. The wireless terminal according to claim 20, wherein the acquisition circuit is further configured to:
create a scan list of channels in the prior geographic region based on one or more system records associated with the prior geographic region, wherein each of the one or more system records includes one or more channels corresponding to a system in the prior geographic region; and
scan the scan list of channels in the prior geographic region to acquire the available channel in the prior geographic region

22. The wireless terminal according to claim 21, wherein the acquisition circuit is further configured to:
acquire at least one of the available channel in the prior geographic region and the available channel in the target geographic region; and
insert a previously acquired channel into the scan lists of channels in the prior geographic region or the target geographic region a plurality of times after every N channels are scanned if the previously acquired channel has been lost.

23. The wireless terminal according to claim 22, wherein the acquisition circuit is further configured to:
create a list of channels most recently acquired by a mobile terminal in the CDMA wireless communications system; and
scan the list of channels most recently acquired before scanning the scan list of channels in the prior geographic region.

24. The wireless terminal according to claim 22 wherein the acquired channel is associated with an acquired system, the acquisition circuit further configured to:
scan the system record associated with the prior geographic region or the target geographic region for a more preferred system than the acquired system if the acquired system is not a most preferred system listed in the system list associated with the prior geographic region or the target geographic region; and
acquire a channel in the more preferred system if a more preferred system is identified during scanning of the system record associated with the prior geographic region or the system record associated with the target geographic region.

25. The wireless terminal according to claim 24, wherein the acquisition circuit is further configured to:
repeatedly scan the system record and acquire a channel in the more preferred system until the acquired channel is in the most preferred system in the system record associated with the prior geographic region or the system record associated with the target geographic region.

26. The wireless terminal according to claim 25, wherein the acquisition circuit is further configured to repeatedly scan the system record and acquire a channel in the more preferred system responsive to a reselection timer.

27. The wireless terminal according to claim 26, wherein the acquisition circuit is further configured to scan a full system list for an available channel in the CDMA wireless communications system if the available channel in the target geographic region was not acquired during scanning of the scan list of channels in the target geographic region.

28. A computer program product for acquiring an available channel in a CDMA wireless communications system, the computer program product comprising computer-readable program code embodied in a computer-readable program storage medium, the computer-readable program code comprising:
computer program code that creates a scan list of channels in a target geographic region responsive to locating a negative system in the target geographic region during a scan of a prior geographic region; and
computer program code that scans the scan list of channels in the target geographic region to acquire the available channel.

29. The computer program product according to claim 28, wherein the computer program code that creates the scan list of channels in the target geographic region comprises computer program code that creates a scan list of channels in the target geographic region based on one or more system records associated with the target geographic region, wherein each of the one or more system records associated with the target geographic region includes one or more channels corresponding to a system in the target geographic region.

30. The computer program product according to claim 29, further comprising:
computer program code that scans the prior geographic region to acquire an available channel in the prior geographic region and to locate negative systems;
wherein the computer program code that scans the scan list of channels in the target geographic region comprises computer program code that scans the scan list of channels in the target geographic region if an available channel is not acquired in the prior geographic region and at least one negative system is located.

31. The computer program product according to claim 30 further comprising:
computer program code that creates a scan list of channels in the prior geographic region based on one or more system records associated with the prior geographic region, wherein each of the one or more system records includes one or more channels corresponding to a system in the prior geographic region; and
wherein the computer program code that scans the prior geographic region comprises computer program code that scans the scan list of channels in the prior geographic region to acquire the available channel in the prior geographic region
